(19) United States
(12) Patent Application Publication
(10) Pub. No.: US 2015/0197235 A1
(43) Pub. Date: Jul. 16, 2015

(54) EXTENDED ELECTRIC MODE OPERATION FOR HYBRID VEHICLE IN GREEN ZONE

(71) Applicant: FORD GLOBAL TECHNOLOGIES, LLC, Dearborn, MI (US)

(72) Inventor: Hai YU, Canton, MI (US)

(73) Assignee: FORD GLOBAL TECHNOLOGIES, LLC, Dearborn, MI (US)

(21) Appl. No.: 14/154,606

(22) Filed: Jan. 14, 2014

(51) Int. Cl. B60W 20/00; F02D 29/02; F02D 28/00

(52) U.S. Cl. CPC B60W 20/106; F02D 28/00; F02D 29/02; Y10S 903/903

(57) ABSTRACT

A system and method for controlling a hybrid electric vehicle includes issuing an internal combustion engine start command in response to a traction battery state of charge falling below a first threshold when the engine is off. The system and method further includes inhibiting an engine start command when the battery state of charge is below the first threshold and the engine is off in response to the vehicle being within a designated geographical region.

### TECHNICAL FIELD

The disclosure relates to hybrid vehicles with engine stop-start logic and to modifying stop-start logic in response to a vehicle location being in a green zone.

### BACKGROUND

Hybrid electric vehicles (HEVs) include engines that may be stopped and started while the vehicle is in motion. When the engine is stopped while the vehicle is in motion, the hybrid vehicle may operate in an “electric only” mode. A controller may issue stop (or “pull down”) or start (or “pull up”) commands to the engine in response to various conditions including a reduced battery state of charge. Plug-in hybrid electric vehicles (PHEVs) are generally equipped with larger batteries and may travel longer distances than other HEVs in electric only mode.

### SUMMARY

A system and method for controlling a hybrid electric vehicle according to the present disclosure includes issuing an internal combustion engine start command in response to a traction battery state of charge (SOC) falling below a first threshold when the engine is off and the vehicle is outside a designated geographical region. The system and method further includes inhibiting an engine start command when the SOC is below the first threshold and the engine is off and the vehicle is in the designated geographical region.

In one embodiment, the method further includes starting the engine in response to the SOC being below a second threshold irrespective of whether the vehicle is within the designated geographical region, where the second threshold is less than the first threshold. In yet another embodiment, the method further includes starting the engine based on whether a travel distance to exit the designated geographical region is greater than a travel distance corresponding with the SOC decreasing to a second threshold. In an additional embodiment, the method further includes issuing an engine start command in response to the vehicle exiting the designated geographical region. In a further embodiment, the designated geographical region is a user-designated geographical region.

A hybrid electric vehicle according to the present disclosure includes an internal combustion engine, a traction battery, and at least one controller. The controller is configured to issue an engine start command in response to a battery SOC falling below a first threshold when the engine is off and the vehicle is outside a designated geographical region. The controller is additionally configured to inhibit the engine start command in response to the SOC being below the first threshold, the engine being off, and the vehicle being within the designated geographical region.

In one embodiment, the controller is further configured to start the engine in response to the battery state of charge being below a second threshold irrespective of whether the vehicle is within the designated geographical region, where the second threshold is less than the first threshold. In another embodiment, the controller is further configured to start the engine based on whether a travel distance to exit the designated geographical region is greater than a travel distance corresponding with the SOC decreasing to a second threshold, where the second threshold is less than the first threshold. In an additional embodiment, the controller is further configured to issue an engine start command in response to the vehicle exiting the designated geographical region. In yet another embodiment, the designated geographical region is a user-designated geographical region.

A method of controlling a hybrid electric vehicle according to the present disclosure includes inhibiting engine start commands, issued in response to a battery state of charge being below a first threshold, in response to a detected vehicle location in a predefined geographical location.

In some embodiments, the inhibiting an engine start command is further in response to a travel distance to exit the predefined geographic location being less than an allowable electric range of the vehicle. In one such embodiment, the method further includes starting the engine in response to the travel distance exceeding the allowable electric range. In another such embodiment, the travel distance to exit the predefined geographic location is increased or decreased by at least one buffer factor. In yet another embodiment, the method additionally includes issuing an engine start command in response to the vehicle exiting the predefined geographic region.

Embodiments according to the present disclosure provide a number of advantages. For example, a plug-in hybrid vehicle according to the present disclosure may drive further in electric-only mode while in a defined geographic region after the battery state of charge falls below a sustaining charge level. Furthermore, methods according to the present disclosure provide for deeper battery discharge while operating in a designated geographic region without adversely affecting battery health. In addition, methods according to the present disclosure permit an engine auto start if the battery state of charge is insufficient to exit the designated geographic area using allowable battery power, thus avoiding continuous engine usage to compensate for unnecessary battery depletion.

The above advantages and other advantages and features of the present disclosure will be apparent from the following detailed description of the preferred embodiments when taken in connection with the accompanying drawings.

### BRIEF DESCRIPTION OF THE DRAWINGS

FIG. 1 schematically illustrates a hybrid electric vehicle.

FIG. 2 illustrates transmitting a green zone location to a hybrid electric vehicle.

FIG. 3 is a flowchart illustrating a method of controlling an engine in a hybrid electric vehicle.

FIG. 4 illustrates a hybrid electric vehicle in a green zone.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

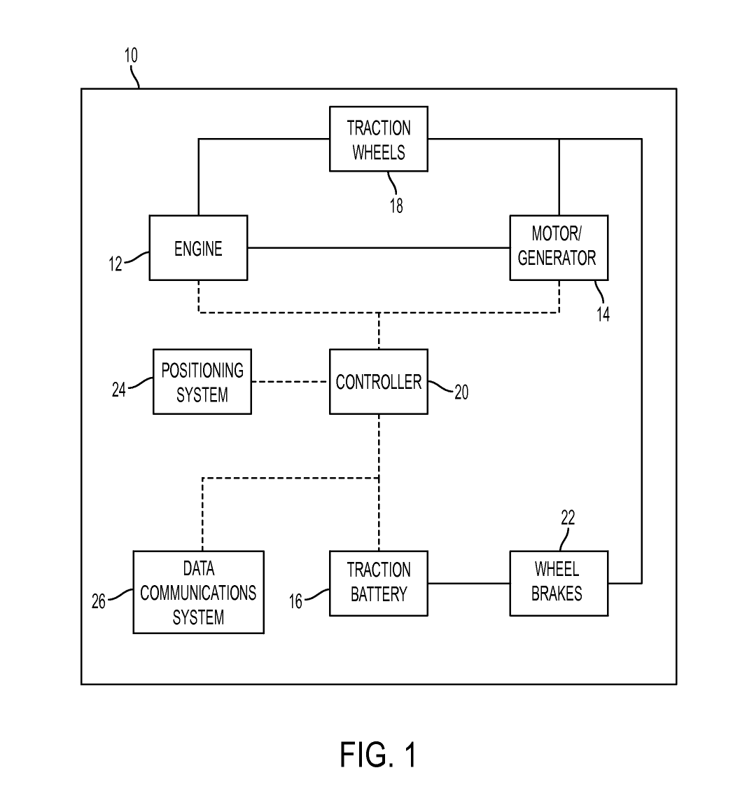

Referring now to FIG. 1, the powertrain of a PHEV 10 includes an engine 12, at least one electric motor/generator 14, and a traction battery 16. The engine 12 and the motor/generator 14 are each provided with torque transmission paths to vehicle traction wheels 18. The engine can also charge the traction battery 16 through the motor/generator 14. The engine 12, motor/generator 14, and traction battery 16 are all in communication with or under the control of at least one controller 20. The controller 20 may be a vehicle systems controller, a combination of an engine system controller and a battery system controller, or other controllers as appropriate. Vehicle kinetic energy may also be recovered and regenerated using wheel brakes 22 to drive the motor/generator and recharge the battery. The PHEV 10 further includes an externally-accessible electrical interface (not shown) for plugging into a charging station.

The PHEV 10 additionally includes a positioning system 24, such as a GPS system, and a data communications system 26. The positioning system 24 and the data communications system 26 are both in communication with or under the control of controller 20. The data communications system 26 may include a cellular data communications device, WiFi, or other appropriate communications devices.

The PHEV 10 is configured to operate in an “electric only” mode. In this mode, the engine 12 is stopped. The motor/generator 14 provides torque to the traction wheels 18 using stored electric energy from the traction battery 16. In electric only mode, regenerative braking is still available to recover kinetic energy as stored electric energy. To avoid over-depleting the traction battery 16, a battery state of charge threshold is provided. This threshold may be referred to as a battery charge sustaining level. As a non-limiting example, the battery charge sustaining level may be set at approximately 30% battery SOC. If the battery state of charge falls below the sustaining level, then the engine 12 will be started in order to charge the traction battery 16. The engine 12 may be started in response to a command from controller 20 or other controllers as appropriate.

In some areas, it is preferable for the vehicle to remain in electric only mode for as long as possible. In some regions, local regulations may make it desirable to operate in electric only mode. As an example, London levies a congestion charge on vehicles operating in the central part of the city during certain peak hours. This congestion charge is fully discounted for electric vehicles. In other regions, the vehicle operator may prefer to operate in electric only mode for other reasons. As an example, the vehicle operator may prefer to operate in electric only mode in his or her neighborhood to reduce local pollution and noise. Collectively, these and other regions in which it is desirable to operate in electric only mode may be referred to as “Green Zones.”

As a countervailing consideration, battery health may be adversely affected by over-depleting the battery. Repeated over-depletion may eventually reduce the battery life, resulting in a decrease of customer satisfaction.

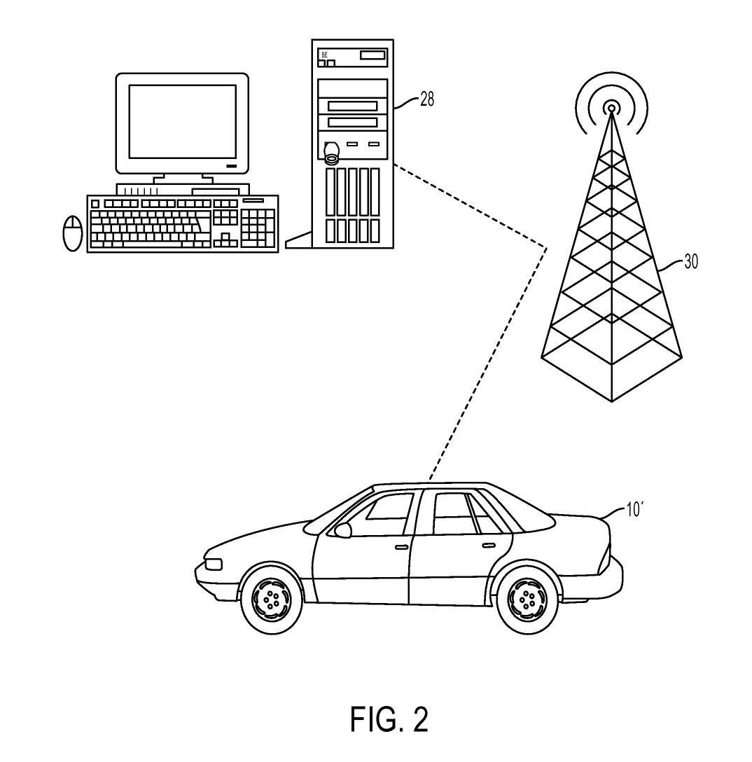

Referring now to FIG. 2, an embodiment of a method for transmitting the defined geographic locations to a PHEV 10′ is shown. The PHEV 10′ may be configured similarly to the PHEV 10 illustrated in FIG. 1. An operator uses a tool on computer terminal 28 to identify zones on a map within which electric only mode is preferred. The operator may be the vehicle operator, an administrator identifying codified congestion zones, or another authorized operator. The location of the identified geographic region(s) is transmitted through the internet to PHEV 10′ via wireless communications device 30. Various other methods are of course possible. For example, a vehicle operator may use a wireless communications device, such as a smart phone, provided with an application equipped to select green zones. The wireless communications device may transmit the green zone location via the Internet, Bluetooth, or other wired or wireless connection between the wireless communications device and the PHEV 10′. If the PHEV 10′ includes an in-vehicle navigation system, the operator may identify the green zones directly into the vehicle navigation system.

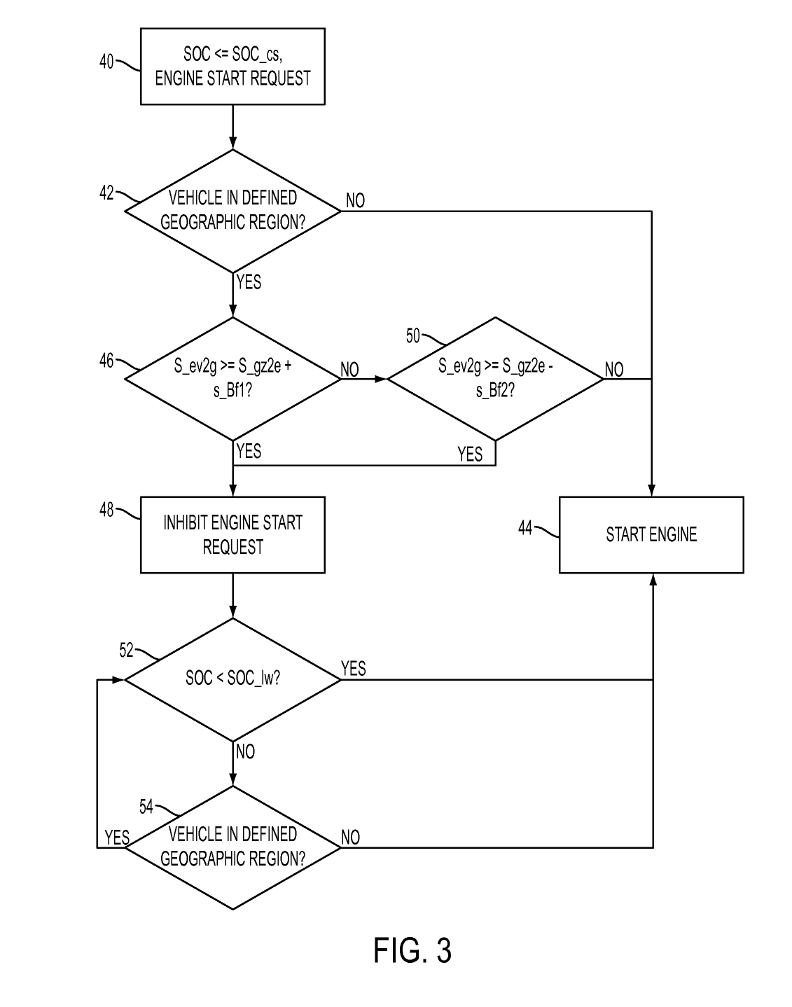

Referring now to FIG. 3, a method for controlling an engine in a PHEV according to the present disclosure is illustrated. A current battery state of charge in the PHEV falls below a sustaining charge level soc_{cs}, in response to which an engine start request is generated as illustrated in block 40. A determination is made of whether the vehicle is within a defined geographic region, as illustrated at operation 42. This determination may be made, for example, by comparing location data obtained from the positioning system 24 against stored green zone coordinates. If the vehicle is not within the defined geographic region, the engine is started as illustrated at block 44. If the vehicle is within the defined geographic region, then a comparison is made between the range to exit the green zone and an electric only range using allowable battery power, as illustrated in operation 46. This calculation will be discussed in more detail in the following paragraphs.

Upon determination that the battery SOC is below the sustaining charge level soc_{cs} and the PHEV is in a defined geographic region, the battery sustaining charge level is temporarily reduced to a second SOC threshold soc_{lw}. The value of soc_{lw} is set at a level such that battery charge depletion down to this level for limited times will not impact battery health or durability. As an example, if the nominal battery sustaining charge level is set at 30%, the reduced sustaining charge level soc_{lw} may be set at 20%. Other values may have course be used, based on various factors including the vehicle type and the size of the battery.

A total distance to exit the defined geographic region, S_{gz2e}, is determined based on mapping data. The distance S_{gz2e} is calculated along a current vehicle route. The current vehicle route may be driver-input via a vehicle navigation system, learned in response to a repeated driving pattern or otherwise determined by vehicle controllers. In addition, a drive energy demand per unit distance along the best route, E_{gz}(s), can be obtained using mapping data and an energy usage estimation function. A total usable energy Esoc_{lw}, from a current SOC level to soc_{lw}, may be calculated based on battery parameters and state. Lastly, vehicle accessory energy usage per unit distance, E_{acc}(s), may be derived from the vehicle accessory power demand and historical energy usage data.

Based on the above distance, an EV distance S_{ev2g} can be calculated using the equation:

∫₀^{S}^{_{ev2g}}(E_{gz}(s)+E_{acc}(s))ds≦Esoc_{lw}

S_{ev2g} is an estimated distance the vehicle can travel in electric only mode supported by allowable battery depletion.

Optionally, first and/or second buffer factors may be implemented. A first buffer factor S_{Bf1} may be provided to compensate for over-estimations of allowable vehicle distance in electric only mode. A second buffer factor S_{Bf2} may be provided to allow electric operation in scenarios in which the allowable electric only vehicle range is only very slightly less of the distance to the end of the defined geographic region.

Returning to operation 46 in FIG. 3, a determination is made of whether the estimated distance the vehicle can travel in electric only mode, S_{ev2g}, exceeds or equals the sum of the range to the end of the defined geographic region, S_{gz2e}, and the first buffer factor, S_{Bf1}. If yes, then the engine start request is inhibited, as illustrated at block 48. The vehicle may thus continue to drive in electric only mode through the defined geographic region.

If no, then a determination is made of whether the estimated distance the vehicle can travel in electric only mode, S_{ev2g}, exceeds or equals the difference of the range to the end of the green zone, S_{gz2e}, and the second buffer factor, S_{Bf2}, as illustrated at operation 50. As discussed above, the second buffer factor is a small value to account for scenarios in which the estimated vehicle range is only slightly short of the range to the edge of the green zone. As an example, the second buffer factor may be on the order of 500 feet. Other values may of course be used. If yes, then the engine start request is inhibited, as illustrated at block 48.

If S_{ev2g} does not exceed the difference of the range to the end of the green zone, S_{gz2e}, and the second buffer factor, S_{Bf2}, then the engine will be restarted, as illustrated at block 44. In this fashion, if the battery state of charge is insufficient to support electric only operation to the edge of the green zone, the battery will not be unnecessarily over-depleted. Furthermore, if the engine is auto started after over-depletion, the engine may run continuously for an extended period to recharge the battery. If this sustained operation occurs while the vehicle is still in the green zone, it may result in more noise and emissions than would arise from normal operation in the absence of over-depletion.

Returning to operation 52, after the engine start request has been inhibited, a comparison is made between a current battery SOC and the reduced sustaining charge level soc_{lw}. If the current battery SOC is greater than or equal to soc_{lw}, then control passes to operation 54 and a determination is made of whether the vehicle is still in the defined geographic region. If yes, then control returns to operation 52. In this fashion, the algorithm continues to monitor the current battery SOC relative to soc_{lw} and the vehicle location within the defined geographic region. If a determination is made that the current battery SOC falls below soc_{lw} or that the vehicle is no longer in the defined geographic region, then the engine is started as illustrated at block 44.

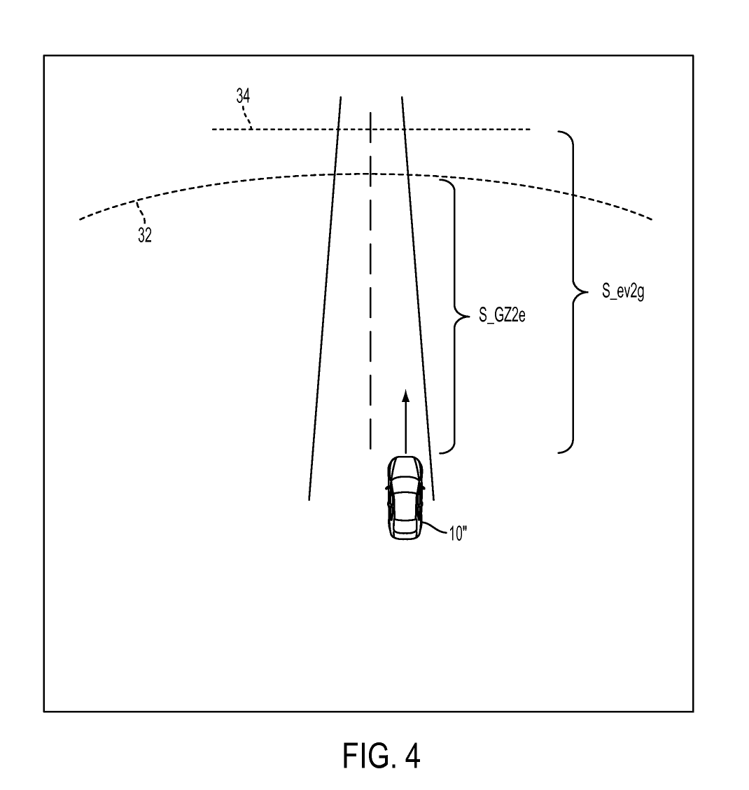

Referring now to FIG. 4, an illustrative example of operation according to the present disclosure is shown. A PHEV 10″ travels along a road, as illustrated by the arrow. The PHEV 10″ is located within a green zone having a pre-defined green zone boundary 32. The green zone boundary may be defined as discussed above with respect to FIG. 2, for example. A controller (not illustrated) in the PHEV 10″ determines that the PHEV 10″ is within the green zone. This determination may be made by comparing stored green zone coordinates against a detected current vehicle location, for example. In response to a battery state of charge falling below a battery sustaining charge level, an engine auto start command is generated. The controller determines a maximum allowable electric only driving distance S_{ev2g} based on a reduced sustaining charge level soc_{lw}. The distance S_{ev2g} is illustrated at numeral 34. This calculation may be performed generally as discussed above with respect to FIG. 3. The controller also determines a distance to the edge of the green zone S_{gz2e}. The controller then compares the distance to the edge of the green zone S_{gz2e} with the allowable electric only mode distance S_{ev2g}. In this case, the allowable electric only mode distance S_{ev2g} exceeds the distance to the edge of the green zone S_{gz2e}, and in response the controller inhibits the engine auto start command. The vehicle will continue to travel in electric only mode until the vehicle exits the green zone or the battery state of charge falls below the reduced sustaining charge level soc_{lw}. In either circumstance, an engine auto start command will be issued and the engine will start. In this embodiment no buffer factor was implemented. In other embodiments, however, first and/or second buffer factors as described above may be provided and implemented.

Although the above embodiments have been discussed with respect to plug-in hybrid electric vehicles, similar strategies may be enacted in other hybrid vehicles having sufficient battery storage to support extended electric-only driving.

As can be seen from the various embodiments, the present disclosure provides a plug-in hybrid vehicle that may drive further in electric-only mode while in a defined geographic region after the battery state of charge falls below a sustaining charge level. In addition, the present disclosure provides for deeper battery discharge while operating in a defined geographic region without adversely affecting battery health. Furthermore, the present disclosure permits an engine auto start if the battery state of charge is insufficient to exit the designated geographic area using allowable battery power, thus avoiding continuous engine usage to compensate for unnecessary battery depletion.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a hybrid electric vehicle comprising:
issuing an engine start command in response to a traction battery state of charge (SOC) falling below a first threshold when the engine is off and the vehicle is outside a designated geographical region; and
inhibiting engine start commands in response to the SOC being below the first threshold when the engine is off and the vehicle being within the designated geographical region.

2. The method of claim 1, further comprising starting the engine in response to the SOC falling below a second threshold that is less than the first threshold irrespective of whether the vehicle is within the designated geographical region.

3. The method of claim 1, further comprising:
starting the engine based on whether a travel distance to exit the designated geographical region is greater than a travel distance corresponding with the SOC decreasing to a second threshold that is less than the first threshold.

4. The method of claim 1, further comprising issuing an engine start command in response to the vehicle exiting the designated geographical region.

5. The method of claim 1, wherein the designated geographical region is user designated.

6. A hybrid electric vehicle comprising:
an internal combustion engine;
a traction battery; and
at least one controller configured to issue an engine start command in response to a battery state of charge (SOC) falling below a first threshold when the engine is off and the vehicle is outside a designated geographical region, and to inhibit engine start commands in response to the SOC being below the first threshold when the engine is off and the vehicle being within the designated geographical region.

7. The hybrid electric vehicle of claim 6, wherein the at least one controller is further configured to start the engine in response to the SOC falling below a second threshold less than the first threshold irrespective of whether the vehicle is within the designated geographical region.

8. The hybrid electric vehicle of claim 6, wherein the at least one controller is further configured to start the engine based on whether a travel distance to exit the designated geographical region is greater than a travel distance corresponding with the SOC decreasing to a second threshold less than the first threshold.

9. The hybrid electric vehicle of claim 6, wherein the at least one controller is further configured to issue an engine start command in response to the vehicle exiting the designated geographical region.

10. The hybrid electric vehicle of claim 6, wherein the designated geographical region is user designated.

11. A method of controlling a hybrid electric vehicle comprising:
inhibiting engine start commands, issued in response to a battery state of charge being below a first threshold, in response to a detected vehicle location being in a predefined geographic location.

12. The method of claim 11, wherein the inhibiting is further in response to a travel distance to exit the predefined geographic location being less than an allowable electric range of the vehicle.

13. The method of claim 12, further comprising starting the engine in response to the travel distance exceeding the allowable electric range.

14. The method of claim 12, wherein the travel distance to exit the predefined geographic location is increased or decreased by at least one buffer factor.

15. The method of claim 11, further comprising issuing an engine start command in response to the vehicle exiting the predefined geographic location.
